(19) United States
(12) Patent Application Publication
(10) Pub. No.: US 2007/0008724 A1
(43) Pub. Date: Jan. 11, 2007

(54) Plate member and assembly for hanging a decorative lighting string on a structure

(76) Inventor: Michael R. Raska, Needville, TX (US)

Correspondence Address: ALBERT B. KIMBALL, JR.;BRACEWELL & PATTERSON L L P, 711 LOUISANA SUITE 2300, HOUSTON, TX, 77002, US

(21) Appl. No.: 11/177,387

(22) Filed: Jul. 8, 2005

(51) Int. Cl. F21V 21/00

(52) U.S. Cl. 362/249; 362/252; 362/806

(57) ABSTRACT

A light attachment member, for example a bar or plate, that can be made of wood, synthetic resin, or hard rubber used to attach strings of decorative lights to a pole, post, tree branch or tree trunk. A number of pegs, lugs, tabs, rods or the like are located at spaced positions from each other along the extent of the bar to serve as supports or anchors for the electrical cord connecting the string of lights. The bar or plate may be flat, curved or angled, as desired in cross-section. The pegs or rods can be separate items later attached to the pegs or rods, or they may be integrally formed as parts of the bar or plate.

### FIELD OF THE INVENTION

The present invention relates to a plate member and assembly for hanging a decorative lighting string on an object or structure, and more particularly for attaching the lighting string about peripheral segments of the structure.

### DESCRIPTION OF THE PRIOR ART

It has been a popular custom to hang decorative strings of lighting on or from buildings, trees, light poles or other similar objects or structures, particularly in connection with the celebration of certain holidays, for example, Christmas. Traditionally, these lighting strings have been hung either by wrapping the light string around the structure or by affixing the light string to the structure. It has often been difficult, however, to hang or install these light strings in a convenient and unburdensome manner.

As a result, there have been proposed various devices and related methods to aid in hanging decorative lighting strings on or from structures. For example, mounting devices were proposed that were fastened or affixed to a structure using nails, screws or other similar attachment means. The lighting string was then draped from the mounting device. Fastening the mounting devices to the structure, however, was inconvenient, time-consuming and typically physically scarred or damaged the structure.

Other previously proposed devices included brackets or bases with clamps that could be affixed to, for example, gutters or shutters on the outsides of homes or other buildings. The lighting string would hang from the brackets or bases. These specialized devices were not, however, adaptable or suitable for use in decorating, for example, trees, lamp posts or other outdoor cylindrical structures to which the clamps were not affixable, and wherein the lights were wrapped around, as opposed to hung from, the structure.

Certain devices utilized multiple tubular members strung together using a decorative lighting string. The lighting string was passed through the hollow interior of each of the tubular members to secure the lighting string to the members, and the light string and member combination was then wrapped around a tree or other similar object. Once wrapped around the tree, the two or more members were connected to each another using, for example, a hook and clasp, to secure the assembly onto the structure. It was often difficult, however, to pass the lighting string through the hollow interior of the tubular members. Also, these devices typically required preliminary assembly and had multiple parts or components which were prone to detaching or breaking. Also, the tubular shape of the members did not provide adequate lateral support for the device against the structure.

Other previous devices included a large pliable frame which could be formed or shaped into a variety of designs or shapes. The lighting string could be draped around or attached to the device in a decorative fashion. These frames were typically large, bulky and difficult to install. Further, the user was restricted with regard to the variety of decorative shapes into which the frame or lighting string could be arranged. In certain smaller frame devices, the frame was only adaptable to accept the lighting string in certain areas, for example, at or near the light sockets on the string, which made assembly difficult.

### SUMMARY OF THE INVENTION

Briefly, the present invention provides an apparatus for displaying a decorative lighting string on a structure. The apparatus includes a plate member having a front surface and a rear surface. The rear surface is preferably placed adjacent the structure and extends along the longitudinal axis of the structure. The apparatus also preferably includes a plurality of engagement members formed along the extent of the front surface of the plate member and extending outwardly transverse to the longitudinal axis of the plate member. The engagement members are adapted to engage the decorative light string about peripheral sections of the structure to form a decorative lighting display therewith.

If desired, the plate member may be shaped such that the surface area of the rear surface is attachable or engagable along at least portions thereof with the structure to provide lateral stability for the plate member with respect to the structure. For example, the rear surface of the plate member can be curved in cross-section along an axis coextensive with the extent of the structure. Also, the plate member can include a first member and a second member intersecting along their vertical extents to form an angle therebetween, whereby sections of the first and second members along their vertical extents contact the structure.

The plate member is used to attach one or more strings of decorative or holiday lighting to a pole, post, tree branch, tree trunk or other similar object or structure. A number of pegs, lugs, tabs, rods or other similar engagement members are located at spaced positions from each other along the extent of the front surface of the plate member to serve as supports or anchors for the lighting string. The pegs or rods can be separate items that are later attached to the plate member, or they may be integrally formed as parts of the plate member. The plurality of engagement members protrude outwardly in a direction transverse to the longitudinal axis of the plate member. The engagement members are adapted to engage the cord of the decorative light string and secure the string as the string wrappingly surrounds peripheral segments of the structure. Preferably, at least one of the engagement members is adaptable to lie flush with the front surface of the plate member and is foldable away from the plate member. The engagement member may be foldable away from the plate member in a direction transverse to, or alternatively, along, the longitudinal extent of the plate member.

The plate member and light string can together form an assembly for displaying decorative lighting on an object or structure. The plate member is positioned adjacent the structure, and has engagement members disposed at spaced apart intervals thereon and extending outwardly therefrom. A light string having a plurality of lights thereon is attachably engagable to the engagement members about peripheral segments of the structure. The plate member and light string form the assembly enclosing the structure and forming a decorative lighting display therewith.

A plurality of plate members may be positioned at different locations adjacent the structure. Each plate member has engagement members disposed at spaced apart intervals thereon and extending outwardly therefrom. A light string having a plurality of lights thereon is attachably engagable to the engagement members on the plate members about peripheral segments of the structure. The plate members are connected by the light string, such that the light string and plate members form the assembly that encloses the structure and forms a decorative lighting display therewith.

### BRIEF DESCRIPTION OF THE DRAWINGS

The various aspects of the invention will now be described by way of example only with reference to the accompanying drawings, in which:

FIG. 1 is a front elevation view of a plate member and decorative lighting string assembly installed on an object according to an embodiment of the present invention.

FIG. 2 is a rear elevation view of the structure illustrated in FIG. 1.

FIG. 3 is an isometric view of a plate member according to the present invention.

FIG. 4 is an isometric view of another plate member according to the present invention.

FIG. 5 is an isometric view of another plate member according to the present invention.

FIG. 5A is an isometric view of a plurality of connected plate members according to the present invention.

FIGS. 6, 7 and 8 are schematic diagrams of a decorative lighting string being installed on a structure according to the present invention.

FIG. 9 is a view, taken partially in horizontal cross-section, of a decorative lighting assembly installed on a structure according to the present invention.

FIG. 10 is a view, taken partially in horizontal cross-section, of another decorative lighting string installed on a structure according to the present invention.

### DETAILED DESCRIPTION

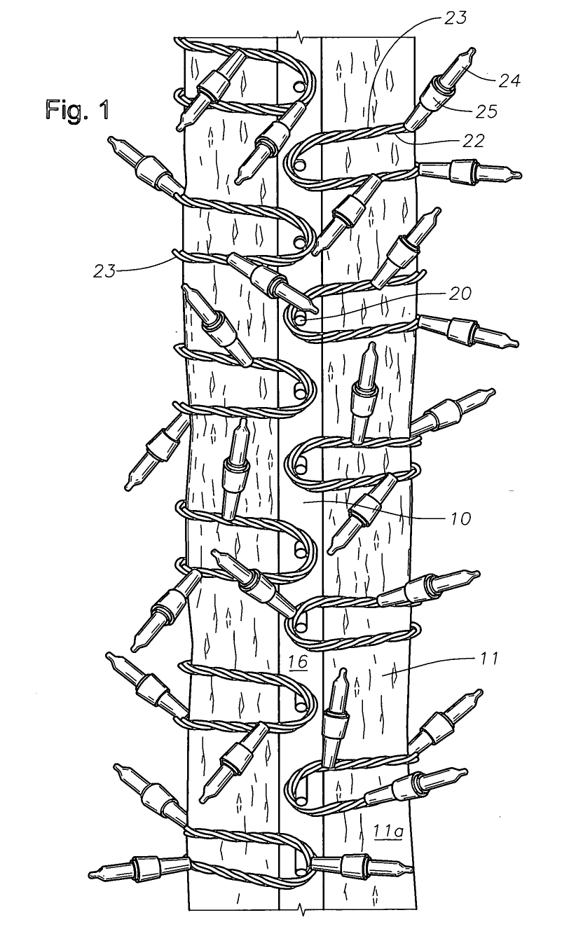

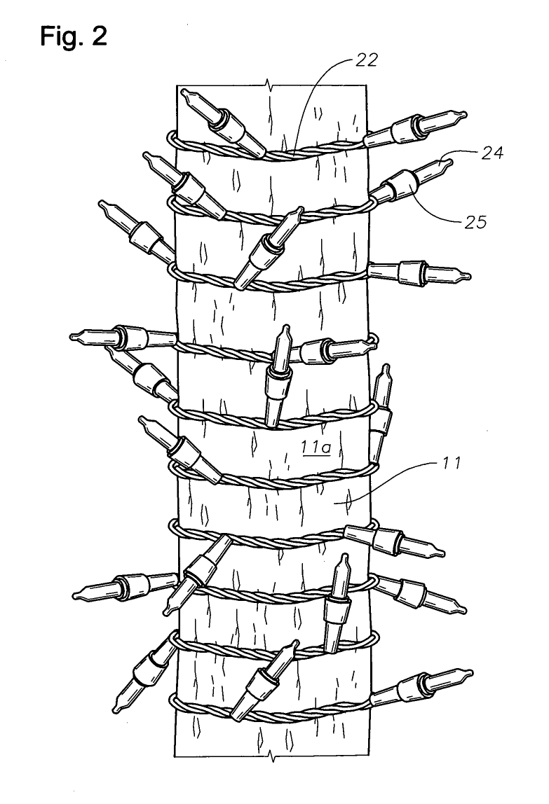

As illustrated in FIG. 1, a plate member 10 according to an embodiment of the present invention is used to attach one or more strings of decorative lighting 22, for example, Christmas or other holiday lighting, about the periphery of a structure, such as a pole, post, tree branch, tree trunk, or other similar structure 11. Other items without decorative lighting disposed thereon, for example, streamers or garlands, can also be attached to a structure 11 using the plate member 10. According to the present invention, a structure 11 can be an upright, angularly disposed or other similar object having an elongate shaft-like segment upon which a decorative lighting string 22 can be attached, hung or otherwise disposed.

The light string 22 typically comprises an electrical cord 23 with a plurality of light sockets 25 disposed at spaced apart locations thereupon, and a plurality of light bulbs 24 detachably affixable to the light sockets 25. Each light bulb 24 can be selected according to its color, shape, intensity, and lighting pattern. A light bulb 24 can preferably be removed from its respective light socket 25 if, for example, the light bulb 24 burns out, and replaced with another light bulb 24 of the same or a different color, shape, intensity or lighting pattern. Alternatively, the light bulbs 24 can be permanently affixed within the respective light sockets 25 or to the electrical cord 23. The light bulbs 24 can be like-colored or multi-colored to provide the desired decorative effect.

The light string 22 preferably has a first end with a male plug member disposed thereon and a second end with a female recipient plug member disposed thereon. The light string 22 may comprise a single continuous string, or it may comprise a series of light strings 22 connected to one another via, for example, plugging the respective male and female plug members of the separate light strings 22 together. An end portion of the light string 22 having a male plug member is connected to an electrical outlet, or alternatively, to one or more extension cords that ultimately connect to said electrical outlet, to provide power for the light bulbs 24 in the lighting display.

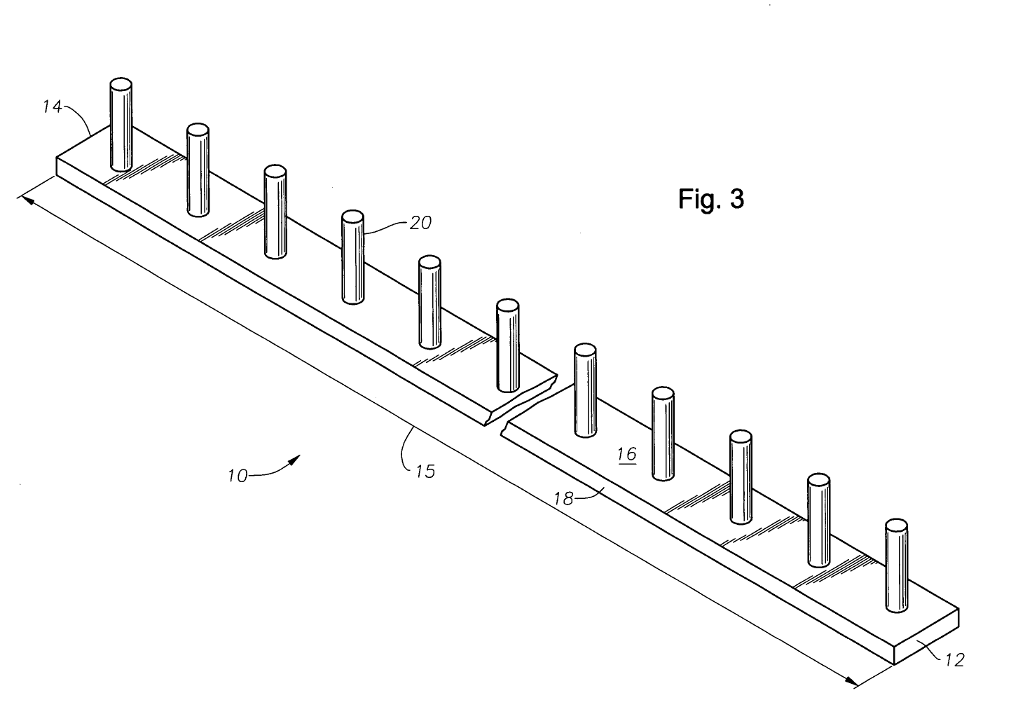

As illustrated in FIG. 3, plate member 10 has a first end 12, a second end 14 and an elongate section 15 extending therebetween. The elongate section 15 of plate member 10 preferably has a front surface 16 and a rear surface 18. When plate member 10 is in use as shown, for example, in FIG. 1, the rear surface 18 is typically positioned to face and be in contact along at least some portion of its surface with an outer peripheral surface 11a of the structure 11. Thus, the rear surface 18 may engage the peripheral surface 11a fully when the rear surface 18 conforms to the shape of the peripheral surface 18. In other cases, partial contact occurs between the surfaces 18 and 11a to provide a desired amount of lateral support and stability for the plate member 10 so that the plate member 10 does not move unnecessarily about the structure 11. The front surface 16 preferably faces outwardly from the structure 11 in an opposite direction from the rear surface 18. Plate member 10 can be constructed of wood, plastic, synthetic resin, hard rubber, or any other material of suitable strength or durability.

A plurality of engagement members 20, for example, pegs, lugs, tabs, rods or the like, are located at spaced positions from each other along the longitudinal extent of the plate member 10 in the direction of its greatest length. The engagement members 20 can be integrally formed as parts of the plate member 10, or they may be separate items made as component pieces later attached to the plate member 10. The engagement members 20 serve as supports or anchors for the decorative light string 22 that is wrapped around the structure 11 to decorate the structure 11. Any number of engagement members 20 can be disposed upon or utilized in connection with the plate member 10, as desired. The lugs utilized as engagement members 20 are typically at least ⅜″ in length, although each individual member 20 can be any desired length or width.

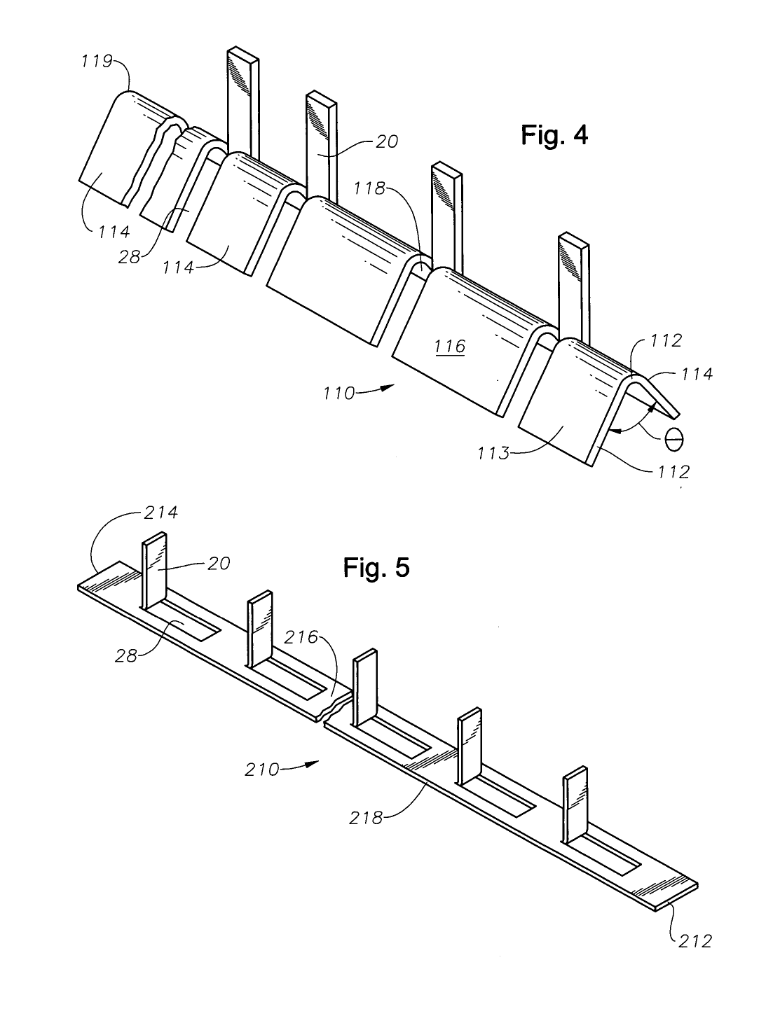

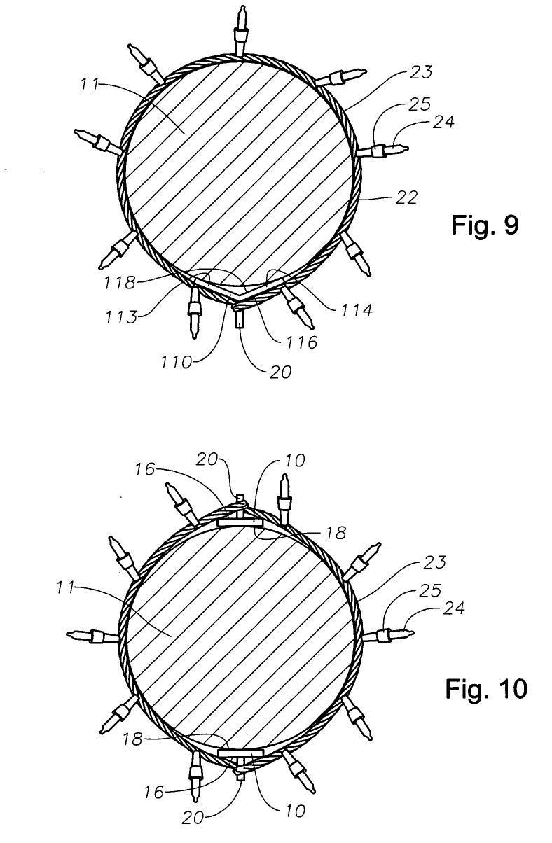

A plate member according to the present invention can be flat, as shown in FIGS. 1, 3 and 5, curved, as shown in FIG. 4, or angled or bent, as shown in FIG. 9, in cross-section, as desired and depending upon the shape of the structure 11, to provide the desired amount of engagement between the rear surface 18 of the plate member and the outer peripheral surface 11a of the structure 11 to achieve lateral support and stability with respect to the structure 11.

For example, in an embodiment of the present invention shown in FIG. 4, plate member 110 has a front surface 116, a rear surface 118 and a curved center member 112 having a pair of legs 113 and 114 which extend away therefrom. An angle Θ is formed between legs 113 and 114 at the curve of curved center member 112. Generally, the location and extent of engagement between the rear surface 118 of plate member 110 and the peripheral surface 11a of the structure 11 is determined by the angle Θ formed between legs 113 and 114.

Thus, when the angle Θ between legs 113 and 114 is relatively large, that is, between 90 degrees and 180 degrees, the rear surface 118 of plate member 110 will contact the peripheral surface 11a of structure 11 primarily along the section of legs 113 and 114 located relatively closely to curved center member 112. In this case, the structure 11 could also potentially sit flush against the curved center member 112, depending upon the size of angle Θ and the shape of the structure 11. In other cases, when the angle Θ between legs 113 and 114 is relatively small, that is, less than 90 degrees, the structure 11 will contact the rear surface 118 along the extent of legs 113 and 114 a further distance from the curved center member 112 than if the angle Θ between legs 113 and 114 were larger. In either case, however, partial contact occurs between the surfaces 18 and 11a to provide a desired amount of lateral support and stability for the plate member 110 so that the plate member 110 does not move unnecessarily about the structure 11.

If desired, the plate member 110 can be pliable or flexible such that the curve of center member 112 can be shaped to exactly match the curved shape of structure 11. Further, the leg members 113 and 114 can also be pliable or flexible such that the legs 113, 114 can be shaped to conform to the shape of the structure 11. This embodiment would provide an increased amount of contact between the rear surface 118 of the plate member 110 and the outer peripheral surface 11a of the structure 11 to achieve lateral support and stability with respect to the structure 11.

In embodiments utilizing a curved plate member 110 with nonpliable legs 113 and 114, plate member 110 preferably contacts the structure 11 in at least two different locations, that is, along the rear surface 118 of both leg 113 and leg 114. This advantageously provides lateral support and stability for the plate member 110 with respect to the structure 11. Similarly, FIG. 9 illustrates an embodiment of the present invention in which the plate member 110 is angled or bent and the legs are straight and nonpliable. Leg 113 and leg 114 of plate member 110 each engage the outer peripheral surface 11a of the structure 11 in at least two different contact points, to provide lateral support and stability for the member 110 and to prevent unnecessary movement of member 110 about the structure 11.

In the embodiment illustrated in FIG. 4, the engagement members 20 are rectangular-shaped tabs. These tab-shaped members 20 advantageously provide for increased engagement with, and reduced sliding movement of, the light string 22 as opposed to, for example, rounded peg-shaped members 20. The engagement members 20 are adapted to lie flush with leg 113 of the plate member 110 and are foldable away from leg 113 of plate member 110 in a direction transverse to the longitudinal extent of the plate member 110. If desired, the members 20 can be foldable in any direction that provides for stability of the member 110 and secure engagement of the string 22. This allows the user to select certain engagement members 20 to be raised for use while leaving others in the flush position, if desired, and thus provide for variable spacing between individual ones of the engagement members 20. The varying spacing allows adjustment of the location of portions of the light string 22 along the extent of the structure 11. The adjustable spacing of engagement members 20 also prevents, for example, entanglement of the light string 22 on any unused engagement members 20. Alternatively, the user can raise all of the engagement members 20, if desired, to provide the maximum available number of tabbed members 20 for engagement with the light string 22. In certain embodiments, the engagement members 20 can be moved up from the flush position to the raised position by, for example, pushing upward through an aperture 28 formed in leg 113 of plate member 110 under the flush engagement member 20. The aperture 28 can be larger than, smaller than or sized similarly to the engagement member 20 in length, width and depth. If desired, some or all of the engagement members 20 can be folded back into the flush position relative to leg 113 to, for example, reduce the number of available engagement positions or for storage purposes.

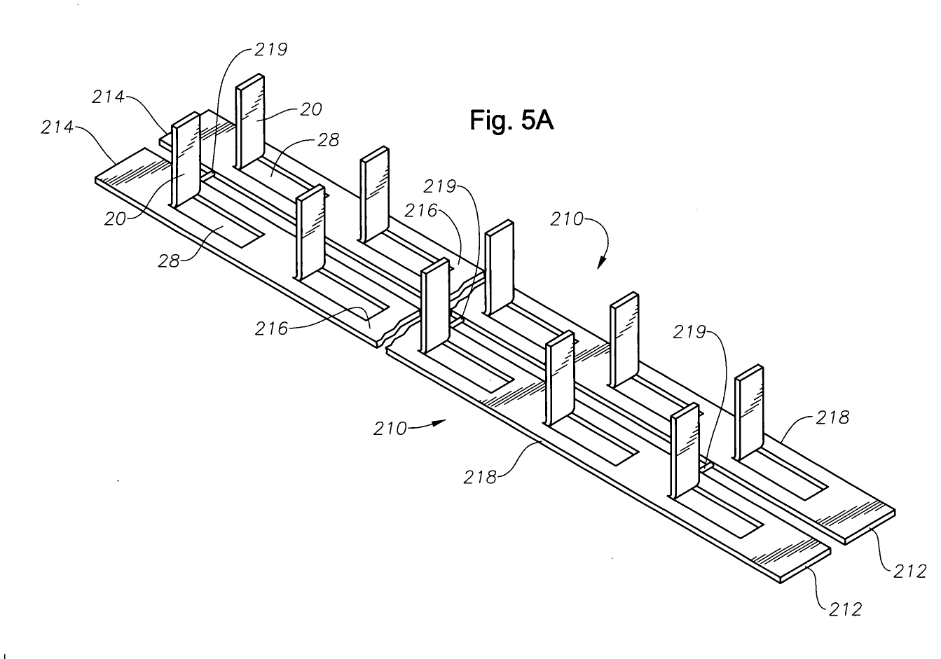

In the embodiment illustrated in FIG. 5, the plate member 210 is a flat bar, and the engagement members 20 are rectangular-shaped tabs. One or more of the engagement members 20 are adapted to lie flush with the plate member 210 and are foldable away from the plate member 210 in a direction along the longitudinal extent of the plate member 210. This allows the user to select certain engagement members 20 to be raised for use while leaving others in the flush position, if desired, and thus provide for variable spacing between individual ones of the engagement members 20. Alternatively, the user can raise all the engagement members 20, if desired. The varying spacing allows adjustment of the location of portions of the light string 22 along the extent of the structure 11. The adjustable spacing of engagement members 20 also prevents, for example, entanglement of the light string 22 on any unused engagement members 20. As with the embodiment shown in FIG. 4, the user can also raise all the engagement members 20, if desired, to provide the maximum available number of members 20 for engaging the light string 22. In certain embodiments, the engagement members 20 can be moved up from the flush position to the raised position by, for example, pushing upward through aperture 28 formed in the plate member 210 under the flush engagement member 20. If desired, some or all of the engagement members 20 can be folded back into the flush position relative to plate member 210, for example, to reduce the number of available engagement positions or for storage purposes. Generally, the plate members 10, 110, 210 shown in the various embodiments of the invention can be of any desired length or width and contain any desired number of engagement members 20.

In the operation of the present invention, a user positions the plate member, such as plate member 10 of FIG. 3, adjacent to the structure 11 being decorated, with the rear surface 18 of the plate member 10 nearest to the outer peripheral surface 11a of structure 11 and the longitudinal extent of the plate member 10 preferably aligned in a direction substantially parallel to that of the longitudinal extent of the structure 11. The plate member 10 can be any length, width or thickness needed to achieve the desired decorative effect or provide the necessary lateral support.

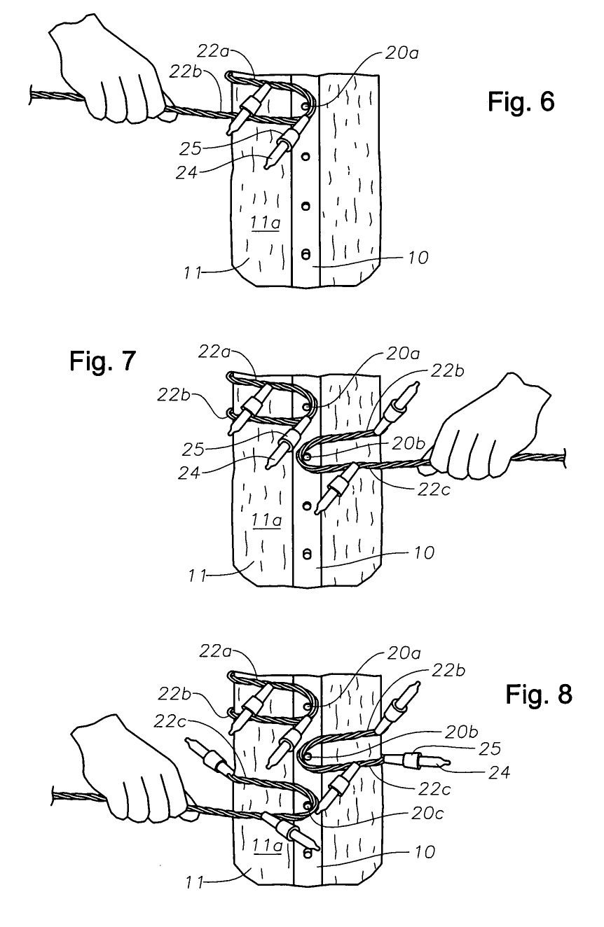

Next, as illustrated in FIGS. 6-8, the user secures the light string 22 to a first engagement member 20a on the plate member 10, typically by wrapping a segment of the light string 22a around or about the engagement member 20a a desired number of times. Once the segment of light string 22a is secured to the first engagement member 20a, an adjacent slack segment of the light string 22b is wrapped around or about the outer perimeter of the structure 11 until the segment of light string 22b generally surrounds or encloses the structure 11 and is again disposed at or near the plate member 10. The light string is then secured to a second engagement member 20b on the plate member 10. The segment of the light string 22b that has been wrapped around the structure 11 is preferably pulled taut before the light string 22 is secured to the second engagement member 20b to assure that the plate member 10 is held snugly and securely against the structure 11 by the taut light string 22b.

Once the light string 22 is secured to the second engagement member 20b, the adjacent slack segment of light string 22c is wrapped around the structure 11, preferably in a direction opposite that of the previously wrapped segment 22b, and is engaged with a third engagement member 20c. For example, if the segment of light string 22b between the first engagement member 20a and the second engagement member 20b was wrapped in a clockwise direction, the segment of light string 22c between the second engagement member 20b and the third engagement member 20c will preferably be wrapped in a counterclockwise direction.

This method of wrapping the structure 11 in opposite directions using the plate member 10 as a support brace is continued until the desired decorative look or appearance for the wrapped structure 11 is achieved. By wrapping the structure 11 in this manner, the plate member 10 is held securely against the outer surface of the structure 11 by the light string 22, and the plate member 10 and light string 22 together support the assembly about the structure 11. If desired, the plate member 10 can be further secured to the structure 11 by using removable double sided adhesive, or one or more nails, screws or other attachment means, either initially or after the lighting string 22 has been attached to the structure 11. Also, the end portions of the lighting string 22 can be affixed to the plate member 10 or structure 11 or preferably wrapped or looped around one or more engagement members 20 and allowed to hang loosely from the last such engagement member 20, as desired. At least one end of the lighting string 22 will be plugged into an electrical outlet, or alternatively, to one or more extension cords that ultimately connect to said electrical outlet, to provide power for the light bulbs 24 in the lighting display.

The plate member can be flat, as shown in FIGS. 1, 3 and 5, curved, as shown in FIG. 4, or angled or bent, as shown in FIG. 9, in cross-section. Preferably, the shape of the member 10 along its rear surface 18 generally conforms to the shape of the outer surface of the structure 11 to provide substantial lateral stability for the member 10 against the structure 11.

If desired, a plurality of plate members 10 can be used to hang one or more light strings 22 from the structure 11, as shown in FIG. 10. The plate members 10 can be placed in different locations on the outer perimeter of the structure 11, and the light strings 22 can be wrapped around the perimeter segments of the structure 11 between the respective plate members 10 to connect the plate members 10 to one another. Usually, the strands of the light string 22 may serve as a main connector between the plate member or members 10 and the structure 11. Accordingly, the plate member 10 and light string 22 together form a composite assembly that supports itself as a unitary lighting assembly about the structure 11 and does not fall or slip or slide away from the structure 11. Additionally, a plurality of plate members 10 can be attached or connected in series, if desired, along the ends 12, 14 of the members 10 to extend the length of the plate member 10.

If the structure 11 has limbs, branches or other like members that extend from the trunk of the structure 11, such as found on a tree, light strings 22 can be hung from or encircle the trunk and also one or more selected ones of these limbs or branches one or more times individually, if desired, as the light string 22 is being wrapped about the structure 11. This will provide additional support for the plate member 10 and light string 22 assembly about the structure 11. When installed using the plate member 10 according to an embodiment of the present invention, the light string 22 advantageously does not completely encircle the structure 11, and so the user is not required to walk or reach completely around the structure 11 during installation or removal. Further, because the light string 22 does not completely encircle the structure 11, it is not required to drag the light string 22 and its fragile bulbs through the branches of the structure 11 in order to hang or remove the light string 22 from the structure 11.

If desired, a plurality of plate members 210 can be affixed side-to-side and adjacent to one another using one or more attachment members 219, as shown in FIG. 5A, for use on structures 11 having, for example, at least one square corner or rounded edge. The attachment member 219 can be in the form of a hinge, an elastic band, or other similar flexible or movable attachment means. Each plate member 210 would preferably sit on a different wall of the structure 11 forming the corner or edge, and the attachment member 219 would pass over the corner or edge and connect the plate members 210. This allows each plate member 210 to contact and achieve lateral support and stability with respect to its respective wall or area of the structure 11. An attachment member 219 such as a hinge or pliable elastic material can also be incorporated into or near the curve of center member 112 in plate member 110, as shown in FIG. 4, so that the member 110 can be shaped to more closely conform to the shape of structure 11 or sit more sturdily against a multiwalled structure 11.

It should be understood that there are multiple variations in the manner in which the light string 22 can engage the engagement members 20 on the plate member 10, and in which the light string 22 may be wrapped about the structure 11, without departing from the scope of the present invention. For example, the light string 22 may engage multiple engagement members 20 in a single pass about the structure 11. Also, the light string 22 may be wrapped multiple times about a single engagement member 22 or about a particular location on the structure 11. Also, the light string 22 may skip successive engagement members 20, or the engagement members 20 can remain in a flush position as in the case of the embodiments shown in FIGS. 4 and 5, along the length of the plate member 10 as it is being wrapped about the structure 11, such that the strands of the light string 22 are not equidistant from each other as they encircle the structure 11. In general, the light string 22 can be wrapped about the structure 11 and engage the plate member 10 in any design or manner that provides a decorative appearance desired by the user and provides the stability necessary to support the light string 20 and plate member 10 assembly about the structure 11.

While the invention has been described herein with respect to certain embodiments, it should be understood by those that are skilled in the art that it is not so limited. The invention is susceptible of various modifications and changes without departing from the scope of the claims.

What is claimed is:

1. An assembly for displaying decorative lighting on a structure, comprising:
a plate member positioned adjacent the structure, the plate member having engagement members disposed at spaced apart intervals thereon and extending outwardly therefrom; and
a light string having a plurality of lights thereon, the light string being attachable to the engagement members about peripheral segments of the structure such that the plate member and light string form the assembly enclosing the structure and forming a decorative lighting display therewith.

2. The assembly of claim 1, wherein the plate member has a front surface and a rear surface, and whereby the plate member is shaped such that the surface area of the rear surface is engagable along at least portions thereof with the structure to provide lateral stability for the plate member with respect to the structure.

3. The assembly of claim 2, wherein the rear surface of the plate member is curved in cross-section along an axis coextensive with the extent of the structure.

4. The assembly of claim 1, wherein the plate member comprises a first member and a second member intersecting along their vertical extents to form an angle therebetween.

5. The assembly of claim 1, wherein at least one of the engagement members is adaptable to lie flush with the front surface of the plate member and is foldable away from the plate member.

6. The assembly of claim 5, whereby the engagement member is foldable away from the plate member in a direction transverse to the longitudinal extent of the plate member.

7. The assembly of claim 5, whereby the engagement member is foldable away from the plate member in a direction along the longitudinal extent of the plate member.

8. An assembly for displaying decorative lighting on a structure, comprising:
a plurality of plate members positioned at different locations adjacent the structure, each plate member having engagement members disposed at spaced apart intervals thereon and extending outwardly therefrom; and
a light string having a plurality of lights thereon, the light string being attachable to the engagement members on the plate members about peripheral segments of the structure such that the plate members are connected by the light string, the light string and plate members thereby forming the assembly enclosing the structure and forming a decorative lighting display therewith.

9. The assembly of claim 8, wherein the plate member has a front surface and a rear surface, and whereby the plate member is shaped such that the surface area of the rear surface is engagable along at least portions thereof with the structure to provide lateral stability for the plate member with respect to the structure.

10. The assembly of claim 9, wherein the rear surface of the plate member is curved in cross-section along an axis coextensive with the extent of the structure.

11. The assembly of claim 8, wherein the plate member comprises a first member and a second member intersecting along their vertical extents to form an angle therebetween.

12. The assembly of claim 8, whereby at least one of the engagement members is adaptable to lie flush with the front surface of the plate member and is foldable away from the plate member.

13. The assembly of claim 8, whereby the engagement member is foldable away from the plate member in a direction transverse to the longitudinal extent of the plate member.

14. The assembly of claim 8, whereby the engagement member is foldable away from the plate member in a direction along the longitudinal extent of the plate member.

15. An apparatus for displaying a decorative lighting string on a structure, comprising:
a plate member having a front surface and a rear surface, the rear surface adapted to be placed adjacent the structure and extend along the longitudinal axis of the structure; and
a plurality of engagement members formed along the extent of the front surface of the plate member and extending outwardly transverse to the longitudinal axis of the plate member, wherein the engagement members are adapted to engage the decorative light string about peripheral sections of the structure to form a decorative lighting display therewith.

16. The apparatus of claim 15, wherein the plate member is shaped such that the surface area of the rear surface is engagable along at least portions thereof with the structure to provide lateral stability for the plate member with respect to the structure.

17. The apparatus of claim 15, wherein the rear surface of the plate member is curved in cross-section along an axis coextensive with the extent of the structure.

18. The apparatus of claim 15, wherein the plate member comprises a first member and a second member intersecting along their vertical extents to form an angle therebetween.

19. The apparatus of claim 15, wherein at least one of the engagement members is adaptable to lie flush with the front surface of the plate member and is foldable away from the plate member.

20. The apparatus of claim 15, whereby the engagement member is foldable away from the plate member in a direction transverse to the longitudinal extent of the plate member.

21. The apparatus of claim 15, whereby the engagement member is foldable away from the plate member in a direction along the longitudinal extent of the plate member.
